(19) United States
(12) Patent Application Publication
(10) Pub. No.: US 2008/0038407 A1
(43) Pub. Date: Feb. 14, 2008

(54) OXYGEN ENHANCED MEAT AND METHOD OF MAKING SAME

(75) Inventor: Peter Musat, Los Angeles, CA (US)

Correspondence Address: SHERIDAN ROSS PC, 1560 BROADWAY, SUITE 1200, DENVER, CO, 80202, US

(73) Assignee: SWIFT & COMPANY, Greeley, CO (US)

(21) Appl. No.: 11/733,300

(22) Filed: Apr. 10, 2007

Related U.S. Application Data
(60) Provisional application No. 60/791,680, filed on Apr. 12, 2006.

(51) Int. Cl. B65B 31/02; A23B 4/22

(52) U.S. Cl. 426/61; 426/129; 426/232; 426/316; 426/392

(57) ABSTRACT

A system and method are described that provide a way to package food products. More specifically, a method of packaging food is described that provides an alternative to packaging food products with carbon monoxide. Instead, oxygen can be used during packaging in an attempt to preserve food product quality and color.

### CROSS REFERENCE TO RELATED APPLICATIONS

This application claims benefit of U.S. Provisional Patent Application Ser. No. 60/791,680, filed Apr. 12, 2006, which is herein incorporated by this reference in its entirety.

### FIELD

The present invention generally relates to modified atmosphere packages and methods of making the same for storing food. More specifically, embodiments of the present invention provide a way to package and store food without using substantial amounts of carbon monoxide to achieve a desirable color of the food product.

### BACKGROUND

Containers have long been employed to store and transfer perishable food prior to presenting the food at a market for subsequent purchase. After perishable foods, such as meats, fruits, and vegetables, are harvested, they are placed into containers to preserve those foods for as long as possible. Maximizing the time in which the food remains preserved in the containers increases the profitability of all entities in the distribution chain by minimizing the amount of spoilage.

The environment around which the food is preserved is a critical factor in the preservation process. Not only is maintaining an adequate temperature important, but the molecular and chemical content of the gases surrounding the food is significant as well. By providing an appropriate gas content to the environment surrounding the food, the food can be better preserved when maintained at the proper temperature or even when it is exposed to variations in temperature. This gives the food producer some assurance that after the food leaves its control, the food will be in an acceptable condition when it reaches the consumer.

Modified atmosphere packaging (MAP) systems for one type of food, raw meats, have typically exposed these raw meats to extremely low levels of oxygen. Packaging systems that previously provided extremely low levels of oxygen were generally preferred because it was believed that the fresh quality of meat could be preserved longer under anaerobic conditions instead of under aerobic conditions. It has long been held that maintaining low levels of oxygen minimized the growth and multiplication of aerobic bacteria. An example of a modified atmosphere environment adhering to these previous standards was a mixture of gases consisting of about 30 percent carbon dioxide and 70 percent nitrogen. Most low oxygen systems attempted to provide an atmosphere for the raw meat of less than 500 ppm oxygen quickly so as to prevent or inhibit excessive metmyoglobin (brown) formation otherwise full “bloom” to oxymyoglobin (red) following storage was not thought possible.

The meat using this low oxygen system takes on a less desirable purple-red color, which few consumers would associate with freshness. The deoxymyoglobin (purple-red color) is generally unacceptable to most consumers. This purple-red color, however, quickly blooms to a bright red color generally associated with freshness when the package is opened to oxygenate the fresh meat by exposure to air. The package is typically opened immediately prior to display of the fresh meat to consumers so as to induce blooming of the meat before display to the consumers.

Another method commonly used to enhance the display of fresh meat to consumers is to use carbon monoxide along with a mixture of other gases such as carbon dioxide and nitrogen to surround the meat prior to packaging. The package is then heat-sealed. Generally, the low-oxygen mix has been thought to extend the shelf life of the meat by up to fifteen days from the normal five days.

However, carbon monoxide also makes meat appear fresher than it actually is by reacting with the meat pigment myoglobin to create carboxymyoglobin, a bright red pigment that potentially masks the natural ageing of meats. The Food and Drug Administration (FDA) has approved the practice of adding carbon monoxide to meat as safe for use. Under current US regulations, processors do not have to indicate on the label that their meat products have been treated with carbon monoxide.

Conversely, a seemingly divergent US department of agriculture regulation prohibits the introduction of ingredients in fresh meat that function to conceal damage or inferiority, or give the appearance that the product is of better or greater value than it actually is. Also, the European Union prohibits food companies from using carbon monoxide with meat and tuna products because such a practice has the ability to maintain a fresh color well beyond the microbial shelf life of the meat, thus masking spoilage. Other countries that have banned the use of carbon monoxide with tuna include, Japan, Canada, and Singapore. The consensus is that the public should have the right to know if carbon monoxide is being used during the preparation of a product they are going to consume.

Since the future regulations of the use of carbon monoxide are currently unknown, strictly relying on carbon monoxide to make meat appear fresher might be unwise. However, using carbon monoxide to process and package a meat product thereby making it appear to be fresh may provide increased sales and revenues to meat producers and processors alike. Thus, there exists a need for a product and method of making such a product that provides a fresh appearance to consumers without the use of substantial amounts of carbon monoxide.

### SUMMARY

It is thus one aspect of certain embodiments of the present invention to provide a product and a method of producing such a product that does not require the use of carbon monoxide in order to appear desirable to consumers. The method uses a combination of gas(es) and holding times and temperatures that can create an end product that overcomes some of the shortcomings of the products mentioned above.

Products made without requiring the use of carbon monoxide to enhance the desirability and methods and systems for producing such products are provided. Although well suited for use in bovine production, advantages offered by the present invention may be realized in the production and packaging of meat products from all age classes of bovine, porcine, and ovine animals. Additionally, embodiments of the present invention may be suitably applied to fish and crustacean products.

In accordance with embodiments of the present invention, a method of producing a modified atmosphere package is provided. The method comprises placing a cut of raw meat within a first package and then backfilling the first package with a mixture of gases. The gas mixture comprises from about 65% to about 100% volume oxygen with the balance, if any, comprising at least one other gas. Examples of other gases used may include, but are not limited to, carbon dioxide, nitrogen, argon, and/or other noble gases. Additionally, trace amounts of carbon monoxide may also be used as a part of the mixture of gases. Holding the gas mixture around the meat at a predetermined temperature for a predetermined amount of time.

As used herein, a “gas mixture” or “gases” is understood to mean one or more gas. For example, a suitable gas mixture may comprise pure or almost pure oxygen. There may be trace amounts of other gases included in the gas mixture, or the gas mixture may be pure oxygen. Additionally, a suitable gas mixture may comprise several gases like oxygen, carbon dioxide, argon, and carbon monoxide in various amounts.

In accordance with an alternative embodiment of the present invention, a method of preparing a modified atmosphere package is provided that comprises supplying a package, a first layer having at least a portion being substantially permeable to oxygen and a second layer being substantially impermeable to oxygen. Placing a retail cut of raw meat within the package and placing the first layer on the package. Supplying a mixture of gases around the meat within the package and the first layer. The gas mixture comprises from about 65% to about 100% volume oxygen with the balance, if any, comprising at least one other gas. Holding the gas mixture around the meat at a predetermined temperature for a predetermined amount of time. Then sealing the first layer to the package and the second layer to at least one of the package and the first layer.

In accordance with at least one embodiment of the present invention, a method of preparing a modified atmosphere package is provided that comprises placing a piece of meat within a first package. Thereafter, backfilling the first package with at least one gas. The at least one gas comprises from about 65% to about 100% volume oxygen with the balance, if any, comprising at least one other different gas. Then, holding the gas around the meat at a predetermined temperature for a predetermined amount of time. Suitable holding temperatures can range between about 30° F. and about 60° F. Additionally, suitable holding times can range from about 1 hour to about 36 hours.

In accordance with further embodiments of the present invention, a modified atmosphere package is provided. The modified atmosphere package comprises a first package. The first package comprises a non-barrier portion substantially permeable to oxygen. The first package is configured and sized to enclose a retail cut of raw meat and create a pocket of a mixture of gases around the meat. The gas mixture comprises from about 65% to about 100% volume oxygen with the balance, if any, comprising at least one other gas.

In accordance with still other embodiments of the present invention, a modified atmosphere package is provided. The modified atmosphere package comprises a first layer and a second layer of packaging. The first layer of packaging is configured and sized to enclose a retail cut of raw meat. The first layer of packaging has a mixture of gases comprising from about 65% to about 100% volume oxygen with the balance, if any, comprising at least one other gas. The first layer has at least a portion being substantially permeable to oxygen. The second layer is substantially impermeable to oxygen and is configured and sized to enclose the meat and the first layer of packaging.

Additionally, in accordance with particular embodiments of the present invention, prior to, or after, being placed in one or both of the packages, the meat product may be treated with competitive bacteria. These competitive bacteria, known as euhygienic bacteria, can be non-pathogenic and/or non-spoilage bacteria. They may competitively inhibit and/or exclude the growth of pathogenic and spoilage bacteria. The use of euhygienic bacteria in the present invention generates little, if any, appreciable malodors or discolorations of food products. In one embodiment of the present invention, euhygienic bacteria are preferably facultative, sacrophilic, gram-positive bacteria, and more preferably, bacteria of the genus Lactobacillus.By inoculating the meat (prior to or after the surrounding the meat with a packing material) with friendly bacteria, the shelf life of the meat may be greatly increased without compromising the quality of the meat or the safety of the consumer. The bacteria can be incorporated at various stages during the production process. For instance, the packages can be treated with the bacteria prior to use. Alternatively, the bacteria can be added to the meat just before being packaged.

In this regard, incorporated by reference in its entirety is U.S. Pat. No. 5,374,433 to Bowling et al. Moreover, incorporated herein by reference is U.S. patent application Ser. No. 10/955,541 to Potter et al., to support claims directed to first reducing undesired bacteria carried into a facility on the hide/hair of animals.

Another embodiment of the present invention is directed to a method of packaging a food product by creating an environment for red meat products such that the red color of the meat products is prolonged, thus appearing to a consumer to have fresh meat characteristics. Yet another embodiment of the present invention is directed to a system for packaging a meat product in accordance with the method as set forth herein.

These and other advantages will be apparent from the disclosure of the invention(s) contained herein. The above-described embodiments and configurations are neither complete nor exhaustive. As will be appreciated, other embodiments of the invention are possible using, alone or in combination, one or more of the features set forth above or described in detail below.

### BRIEF DESCRIPTION OF THE DRAWINGS

FIG. 1 is an isometric view depicting a meat product in packaging in accordance with embodiments of the present invention;

FIG. 2 is a cross-sectional view of a modified atmosphere package including a piece of meat therein in accordance with embodiments of the present invention;

FIG. 3 is a cross-sectional view of an alternate configuration of a modified atmosphere package including a piece of meat therein in accordance with embodiments of the present invention;

FIG. 4 is a cross-sectional view of another configuration of a modified atmosphere package including a piece of meat therein in accordance with embodiments of the present invention;

FIG. 5 is a flow chart depicting a method of packaging a meat product in accordance with embodiments of the present invention; and

FIG. 6 is a flow chart depicting an alternative method of packaging a meat product in accordance with embodiments of the present invention.

### DETAILED DESCRIPTION

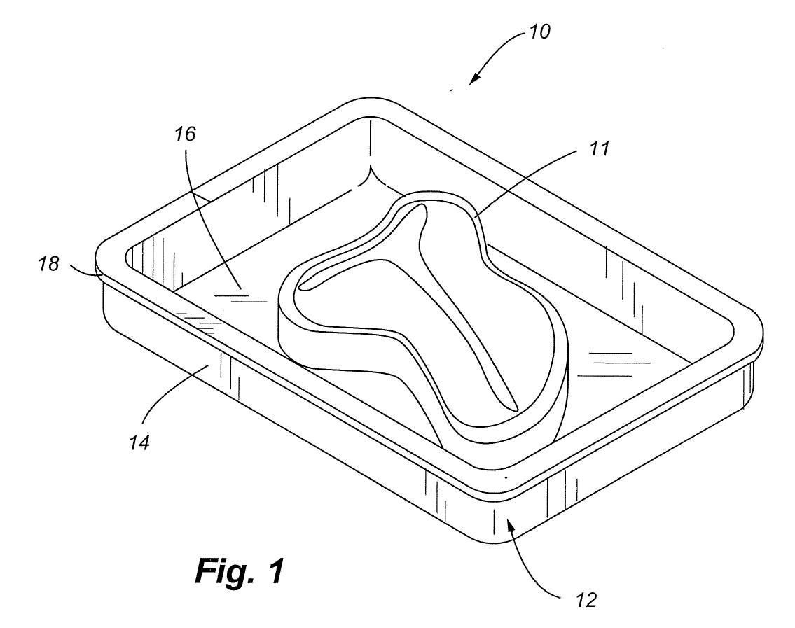

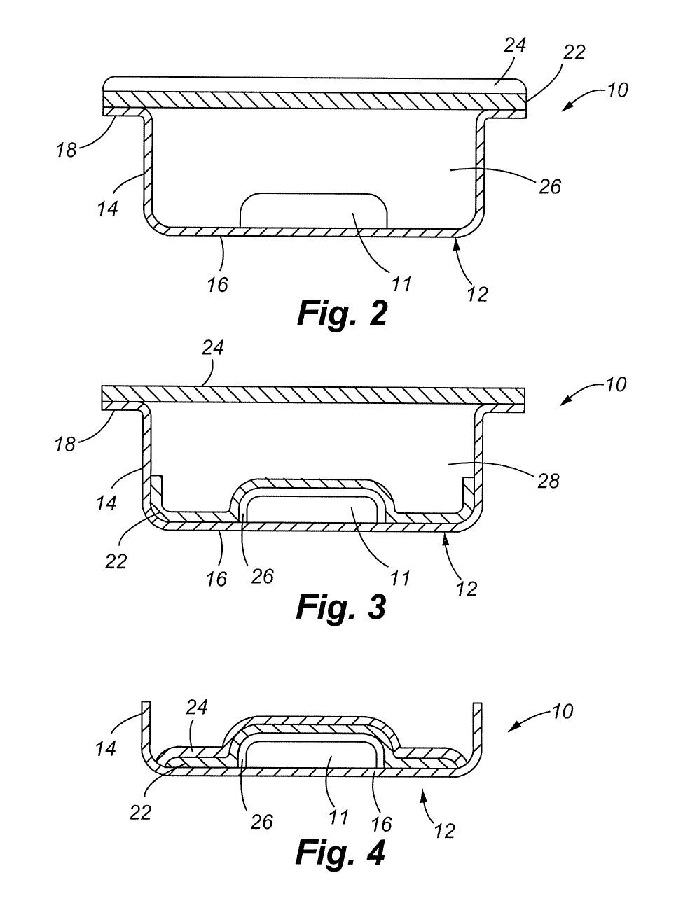

Referring initially to FIGS. 1-4 a modified atmosphere package 10 will be described in accordance with at least some embodiments of the present invention. The modified atmosphere package 10 is typically used to encase or surround a piece of meat 11 or multiple pieces of meat 11. The modified atmosphere package 10 includes a tray 12, an inner package or layer 22, and an outer package or layer 24. The term “package” or “container” as used herein, shall be construed as any device or material capable of holding meat including, but not being limited to, a carton, casing, parcel, holder, tray, flat, bed, film, envelope, and the like. Typically, at least a portion of the inner package or layer 22 is permeable to oxygen. The inner package or layer 22 is included as a part of the tray 16 which may also be permeable to oxygen, although this is not required. The permeability of the layer 22 may be such that it allows gases to pass therethrough with relative ease. For instance, a permeable material allows the equalization of gas pressure on both side of the material, whereas an impermeable will restrict gas flow to the point where a pressure gradient may be created. In accordance with certain embodiments of the present invention, an impermeable layer of material may be such that it restricts up to 99% of gas to pass through over the course of a week or more.

In an alternative embodiment, a single package may be used in lieu of two packages. More specifically, the piece of meat may be placed within a single package or on a tray and surrounded by a single layer, then the meat may be surrounded with the gas mixture as will be described more fully herein.

Exemplary polymers which may be used to form the tray 16 include polystyrene foam, cellulose pulp, polyethylene, polypropylene, or any other known plastic or container material. In one embodiment, a polymeric sheet is used to form the tray 16 and is substantially composed of polystyrene foam with a thickness ranging from about 100-300 mils. Generally, a polystyrene foam tray 12 is used because of its consumer acceptance.

The inner package or layer 22 may comprise a film wrapping or cover also comprised of a polymeric material, such as, but not being limited to, a polyolefin or polyvinylchloride, which is substantially permeable to oxygen. The material used to form the cover or first layer 22 preferably contains additives, which allow the material to cling itself to tray 12. The first layer 22 may have an oxygen permeability greater than about 100 cubic centimeters per 100 square inches in 24 hours.

In a more preferred embodiment, the first layer 22 preferably has rate of permeability greater than about 7000 cubic centimeters per 100 square inches in 24 hours and, most preferably, the material has a rate of oxygen permeability greater than about 10,000 cubic centimeters per 100 square inches in 24 hours. In U.S. Patent Publication No. 2003/0054072 to Merriman et al., which is herein incorporated by this reference in its entirety, a modified atmosphere package having a tray and permeable and semi-permeable layers is described.

The tray 12 is generally rectangular in configuration and includes a continuous sidewall 14, a bottom wall 16, and a continuous rim or flange 18. The continuous sidewall 14 encompasses the bottom wall 16. The continuous rim 18 encompasses an upper edge of the continuous sidewall 14 and projects generally laterally outward therefrom. It is contemplated that tray 12 may be of a different shape than depicted in FIGS. 1-4. A food item such as a retail cut of raw meat 11 is located in a rectangular compartment defined by the bottom wall 16 and continuous sidewall 14. The meat may have been derived from any type of animal, including, but not being limited to, beef, pork, veal, lamb, venison, fish, crustacean, or any other suitable meat product.

The tray 12 may be manually or automatically wrapped with the cover or first layer 22. The first layer 22 is wrapped over the retail cut of meat 11 and about both the sidewall 14 and bottom wall 16, and, due to the clinging characteristic inherent in the first layer 22, these overlapping free ends cling to one another to hold the cover 22 in place. If desired, the over-wrapped tray 12, i.e., the first layer 22, may be run over a hot plate to thermally fuse the free ends of the first layer 22 to the rim 18 of the tray 12, thereby preventing or inhibiting these free ends from potentially unraveling.

Once the meat 11 is covered with the first layer 22, the cavity 26 between the first layer 22 and the meat 11 is backfilled with a gas. Typically the gas is a gas mixture that comprises between about 65% and 100% oxygen with the balance, if any, comprising at least one other gas. Generally the balance is carbon dioxide. For example, if the gas mixture backfilled into the cavity 26 comprises to 65% oxygen then the balance may be 35% carbon dioxide. Additionally, other gases may constitute a part of the balance including nitrogen, argon, or other noble gases. Once the gas has been backfilled into the cavity 26, it is held for a predetermined amount of time at a predetermined temperature. Suitable temperatures may range between 30° F. and 60° F. If the temperature gets too low, then the oxygen may not be able to bind and a desirable red appearance may not be achieved. On the other hand, if the temperature is too high, then bacterial growth may begin and ruin the meat prematurely. For this reason, suitable holding temperatures may range between about 30° F. and 60° F. Furthermore, the gas is held in cavity 26 for a predetermined amount of time. For example, the gas may be held there for 1 to 36 hours with a preferable amount of time being between 18 and 24 hours. Essentially, the gas needs to be maintained around the meat 11 for a suitable enough amount of time to allow the oxygen to bind with the blood located on the surface of the meat 11. A suitable bind time and temperature is determined by the final color displayed by the meat where typically red meat is a more desirable color as compared to purple or brown meat.

Once the first layer 22 has been held for a suitable amount of time, then the second layer 24 is placed over the top of the first layer 22. The second layer 24 may be sized to encapsulate the first layer 22 and the meat 11. Once the second layer 24 is in place, it may be a vacuum packed by typical vacuum packaging machines known in the art. For example, U.S. Patent Publication 2004/0144063 to Countz, which is herein incorporated by this reference in its entirety, discloses a positive pressure packaging system that is used to seal meat products within an open package.

Although the use of nitrogen in the balance of the gas mixture may be used, preferably no nitrogen is used. Additionally, the abundant oxygen may also preclude bacteria from thriving.

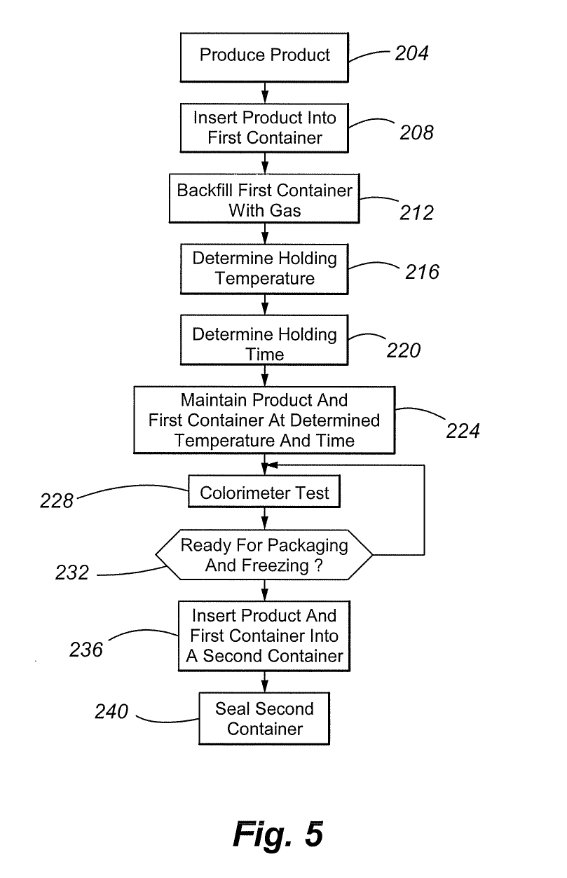

Referring now to FIG. 5, a method of packaging a piece of meat or multiple pieces of meat will be described in accordance with at least some embodiments of the present invention. Initially, the meat product is produced (step 204). As noted above, suitable meat products for use with embodiments of the present invention may include beef, pork, fish, and other types of meat. Once the meat is produced, it is inserted into a first container (step 208). Of course the first product may be set onto a tray 12 and covered with a first layer 22 as described above. Alternatively, the meat is place into a first layer comprising a bag, thus no tray 12 is necessary. Once the meat is within the first layer, the layer is backfilled with gas such that the gas surrounds the meat (step 212). As noted above, a suitable gas mixture may include between about 65% and about 100% oxygen with the balance usually consisting of carbon dioxide. At this point, the meat 11 may also be treated with euhygienic bacteria that will be described in further detail below. Once the meat has been surrounded with the gas mixture in step 212, a holding temperature is determined (step 216). Then depending upon the determined holding temperature, a suitable holding time may be determined (step 220). Each of the holding time and holding temperature may be dependent upon each other, for example the holding time may be determined first and the holding temperature may be determined based on the holding time. Of course, the holding time and temperature may be determined simultaneously depending upon the desired output.

Once the holding time and temperature has been determined, the meat product 11 and the first container 22 are held for that determined time at the determined temperature (step 224). During this time the meat 11 may be subjected to a colorimeter test (step 228). The colorimeter test may be used to ensure quality and to further ensure that similar colors of meat 11 are produced. If, based on either the colorimeter test or the determined time and temperature, the meat 11 is ready for packaging and freezing, as determined in step 232, then the product and the first container are inserted into a second container (step 236). However, if the meat 11 is not ready for packaging (i.e., the meat 11 has not been held for the determined amount of time at the determined temperature and/or the meat 11 has not developed to have a suitable color as determined by the colorimeter test in step 228), then the method returns to step 228 in order to determine when the meat is at a suitable color. Additionally, the meat may be held for longer than the determined amount of time if it has not yet met the colorimeter test requirements.

Once the product has been held for a suitable amount of time and a desired color has been achieved, the meat 11, along with the first container, is placed into a second container as noted above in step 236. Thereafter, the second container is vacuum-sealed according to known methods (step 240).

Advantages offered by embodiments of the present invention include the fact that the meat and/or containers of the meat can be treated with euhygienic bacteria. In an effort to preclude harmful bacteria from spoiling and ruining the meat produced according to embodiments of the present invention, an effective amount of euhygienic bacteria can be incorporated in the meat. Methods of preserving food products by inoculation with an effective amount of euhygienic non-pathogenic, non-spoilage bacteria are described in several U.S. patents including: U.S. Pat. No. 6,569,474 to Clayton et al. entitled, “System for preserving food products”, U.S. Pat. No. 6,287,610 to Bowling et al. entitled, “Method for increasing the tenderness of a meat product”, U.S. Pat. No. 6,039,984 to Bowling et al. entitled, “Method for treating a food processing facility”, and U.S. Pat. No. 5,869,113 to Clayton et al. entitled “Method for preserved food products and food products made thereby”, all of which are incorporated herein by this reference in their entirety.

Furthermore, products that are packaged according to at least some embodiments of the present invention may have been de-haired according to methods disclosed in U.S. patent application Ser. No. 10/955,541 to Potter et al. This may further help to preclude bacteria from spoiling the meat after it has been packaged, thus freshness may extended for the end products.

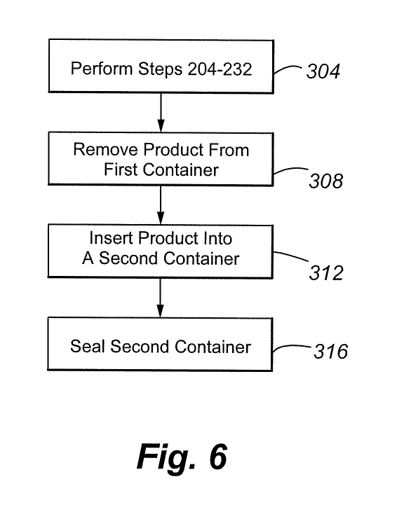

Referring now to FIG. 6 a method of packaging a piece of meat using a single package will be described in accordance with at least some embodiments of the present invention. Initially, steps 204-232 are performed in a similar manner to that described with reference to FIG. 5 (step 304). Once the product has achieved a suitable color, the product is removed from the first container (step 308). A suitable color may be defined as the exact color that is desired for display of the product. Alternatively, a suitable color may be a color that is slightly different from the desired display color, but there is a chance that the color of the product will continue to change until it achieves the desired display color.

After the product is removed it can be inserted into a second container (step 312). The second container may be the final presentation container or may simply be an intermediate container used to transport the meat to its destination. Typically, the second container is substantially impermeable to oxygen and other gases such that once the product is completely surrounded by the second container, no additional gases can access the product through the second container. Thereafter, the second container is sealed with the product inside, thereby creating a product suitable for shipping and/or presentation to an end customer.

The present invention, in various embodiments, includes components, methods, processes, systems and/or apparatus substantially as depicted and described herein, including various embodiments, sub combinations, and subsets thereof. Those of skill in the art will understand how to make and use the present invention after understanding the present disclosure. The present invention, in various embodiments, includes providing devices and processes in the absence of items not depicted and/or described herein or in various embodiments hereof, including in the absence of such items as may have been used in previous devices or processes, e.g., for improving performance, achieving ease and\or reducing cost of implementation.

The foregoing discussion of the invention has been presented for purposes of illustration and description. The foregoing is not intended to limit the invention to the form or forms disclosed herein. In the foregoing Detailed Description for example, various features of the invention are grouped together in one or more embodiments for the purpose of streamlining the disclosure. This method of disclosure is not to be interpreted as reflecting an intention that the claimed invention requires more features than are expressly recited in each claim. Rather, as the following claims reflect, inventive aspects lie in less than all features of a single foregoing disclosed embodiment. Thus, the following claims are hereby incorporated into this Detailed Description, with each claim standing on its own as a separate preferred embodiment of the invention.

Moreover though the description of the invention has included description of one or more embodiments and certain variations and modifications, other variations and modifications are within the scope of the invention, e.g., as may be within the skill and knowledge of those in the art, after understanding the present disclosure. It is intended to obtain rights which include alternative embodiments to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. A method of producing a modified atmosphere package, comprising:
placing at least one piece of meat within a first package;
providing the first package with at least a first gas, the at least a first gas comprising at least about 65 percent oxygen; and
placing the at least one piece of meat within a second package, wherein the second package is substantially impermeable to oxygen.

2. The method of claim 1, wherein the at least one piece of meat and the first package are placed within the second package.

3. The method of claim 1, further comprising removing the at least one piece of meat from the first package prior to placing the at least one piece of meat within the second package.

4. The method of claim 1, further comprising holding the at least a first gas around the at least one piece of meat for a predetermined time at a predetermined temperature.

5. The method of claim 4, wherein the predetermined time is between about 1 and about 36 hours.

6. The method of claim 4, wherein the predetermined temperature is between about 30° F. and about 60° F.

7. The method of claim 1, further comprising:
prior to placing the at least one piece of meat in the second package, subjecting the at least one piece of meat to a colorimeter test;
comparing the results of the colorimeter test to a predetermined color score threshold;
in response to the at least one piece of meat meeting the predetermined color score threshold, placing the at least one piece of meat in the second package; and
in response to the at least one piece of meat not meeting the predetermined color score threshold, precluding placement of the at least one piece of meat in the second package.

8. The method of claim 1, further comprising treating the at least one piece of meat with euhygienic bacteria.

9. The method of claim 1, further comprising treating at least one of the first and second package with euhygienic bacteria.

10. The method of claim 1, wherein the first package comprises a tray and a first layer, and wherein the second package comprises a second layer that is sealed to at least one of the first layer and the tray.

11. The method of claim 1, wherein the at least a first gas comprises about 100 percent oxygen.

12. The method of claim 1, wherein the at least a first gas further comprises carbon dioxide.

13. The method of claim 1, wherein the at least a first gas consists of oxygen and carbon dioxide.

14. The method of claim 1, wherein the at least a first gas is provided within the first package after the placing step.

15. A method of producing a modified atmosphere package, comprising:
placing at least one piece of meat within a first container;
providing the first container with at least one gas, the at least one gas comprising at least about 65 percent oxygen; and
maintaining the at least one gas around the at least one piece of meat for a predetermined amount of time at a predetermined temperature.

16. The method of claim 15, wherein the predetermined amount of time is between about 1 hour and 36 hours.

17. The method of claim 15, wherein the predetermined temperature is between about 30° F. and about 60° F.

18. The method of claim 15, further comprising placing the at least one piece of meat within a second container after the at least one gas has been held around the at least one piece of meat for the predetermined amount of time.

19. The method of claim 15, further comprising:
subjecting the at least one piece of meat to a colorimeter test;
comparing the results of the colorimeter test to a predetermined color score threshold;
in response to the at least one piece of meat meeting the predetermined color score threshold, placing the at least one piece of meat in the second container; and
in response to the at least one piece of meat not meeting the predetermined color score threshold, precluding the placement of the at least one piece of meat in the second container.

20. The method of claim 15, further comprising treating the at least one piece of meat with euhygienic bacteria.

21. The method of claim 15, further comprising treating the first container with euhygienic bacteria.

22. The method of claim 15, wherein the first container comprises a tray and a first layer.

23. The method of claim 15, wherein the at least a first gas comprises about 100 percent oxygen.

24. The method of claim 15, wherein the at least a first gas further comprises carbon dioxide.

25. The method of claim 15, wherein the at least a first gas consists of oxygen and carbon dioxide.

26. A modified atmosphere package adapted to receive at least one piece of meat, the package comprising:
a first container that is substantially permeable to oxygen;
a second container that is substantially impermeable to oxygen; and
a space between the at least one piece of meat and the first container, the space containing at least one gas, wherein the at least one gas comprises at least about 65 percent oxygen.

27. The package of claim 26, wherein the at least one piece of meat is treated with euhygienic bacteria.

28. The package of claim 26, wherein at least one of the first and second container are treated with euhygienic bacteria.

29. The package of claim 26, wherein the first container comprises a tray and a first layer, and wherein the second container comprises a second layer that is sealed to at least one of the first layer and the tray.

30. The package of claim 26, wherein the at least a first gas comprises about 100 percent oxygen.

31. The package of claim 26, wherein the at least a first gas further comprises carbon dioxide.

32. The package of claim 26, wherein the at least a first gas consists of oxygen and carbon dioxide.

33. A method of preparing a meat product, comprising:
washing at least a portion of an animal with a solution comprising sodium hydroxide to reduce microbial levels on a hide of the animal;
removing the hide of the animal;
treating at least a portion of meat from the animal with a non-spoilage, non-pathogenic bacteria;
placing at least one piece of the at least a portion of meat within a first container;
providing the first container with at least one gas, the at least one gas comprising at least about 65 percent oxygen; and
maintaining the at least one gas around the at least one piece of meat for a predetermined amount of time at a predetermined temperature.

34. The method of claim 33, wherein the predetermined temperature is between about 30° F. and about 60° F., and wherein the predetermined amount of time is between about 1 hour and 36 hours.

35. The method of claim 33, further comprising placing the at least one piece of meat and the first container within a second container after the at least one gas has been held around the at least one piece of meat for the predetermined amount of time.

36. The method of claim 33, further comprising:
subjecting the at least one piece of meat to a colorimeter test;
comparing the results of the colorimeter test to a predetermined color score threshold;
in response to the at least one piece of meat meeting the predetermined color score threshold, placing the at least one piece of meat and the first container in the second container; and
in response to the at least one piece of meat not meeting the predetermined color score threshold, precluding placing the at least one piece of meat and the first container in the second container.
